(19) United States
(12) Patent Application Publication
(10) Pub. No.: US 2009/0128656 A1
(43) Pub. Date: May 21, 2009

(54) NO-DRIVE PHOTOGRAPHING DEVICE AND METHOD

(75) Inventor: Haijun YANG, Beijing (CN)

Correspondence Address: SAWYER LAW GROUP LLP, 2465 E. Bayshore Road, Suite No. 406, PALO ALTO, CA, 94303, US

(73) Assignee: BEIJING SIGMACHIP CO., LTD., Beijing (CN)

(21) Appl. No.: 12/272,458

(22) Filed: Nov. 17, 2008

(30) Foreign Application Priority Data
Nov. 21, 2007 (CN) 200710192860.X

(51) Int. Cl. H04N 5/228

(52) U.S. Cl. 348/222.1; 348/E05.031

(57) ABSTRACT

The invention provides a no-drive photographing device and method, wherein the no-drive photographing device comprises a lens for obtaining the optical image of the object. Further, the device comprises: an image sensor for converting the optical image of the object obtained by the lens into a digital image signal, and sending the digital image signal to a digital signal processing unit; and the digital signal processing unit for performing real-time processing to the digital image signal, thereby obtaining a restored image signal, and then sending the restored image signal to the external computer device, wherein the digital signal processing unit has a parameter recording region for recording configuration parameters of the image sensor. As a result, solidifying programs in the digital signal processing chip is realized and the allocation of the sensor in the no-drive PC CAM is realized, thereby decreasing the area of the encapsulated chip and reducing the number of elements which results in lowering the cost. Meanwhile, each module can be configured as desired. As a result the design of the PCB becomes easier, so that it is more convenient to offering and purchasing of products by factories.

### FIELD OF THE INVENTION

The present invention relates to the field of video digital photographing, and more particularly, to a no-drive photographing device and a no-drive photographing method.

### BACKGROUND OF THE INVENTION

In a personal computer camera (hereinafter, referred to as a PC CAM), the key in imaging is the sensor. Different sensors need different configuration parameters to achieve the best imaging effect.

FIG. 1 is the working flow of a typical PC CAM. As shown in FIG. 1, an optical image obtained as a result of a scene is transmitted onto the surface of a sensor through a lens, and then converted into an electrical signal. Next, the electrical signal is converted into a digital image signal following digital analog conversion (A/D) processing. Then, the digital image signal is conveyed to a digital signal processing chip (hereinafter, referred to as DSP), and processed within the chip. Finally, the signal is delivered to the PC for processing through an input-output (IO) interface. Thus the image can then be viewed through the display of the PC.

In FIG. 1, it could be seen that the key in imaging is the sensor, which converts a light source (i.e. optical signal/image) which is then transmitted through a filter into an electronic signal. The obtained electronic signal is then transferred to the DSP, thereby obtaining again the restored image.

At present, all the configuration parameters for realizing the best imaging effect are written by a drive disk, i.e., so-called camera with a driver. As PC CAM develops towards a no-drive process, it becomes a critical technical problem how to allot sensors conveniently.

FIG. 2 shows a working flow chart, realizing a no-drive PC CAM by adding an Electrically Erasable Programmable Read Only Memory (referred to EEPROM) to the DSP in related art. As shown in FIG. 2, first the type of sensor is chosen and the whole imaging effect is regulated, thereby writing the best configuration parameters which can present the best imaging effect into the EEPROM. Therefore, in normal working state, the DSP could achieve the best imaging effect by reading the best configuration parameters from the EEPROM directly.

However, in the related art, although the no-drive PC CAM can be realized, the cost is very high, the area of encapsulated chip becomes larger, and the number of chips increases. Thereby the difficulty of design of the Printed Circuit Board (referred to as PCB) is increased and therefore the design could not be widely propagated. Therefore the existing no-drive PC could not take advantage of the offering and purchasing of these products by factories.

### SUMMARY OF THE INVENTION

To solve problems in the related art, the invention provides a no-drive photographing device and method which could reduce the number of chips in the related art, and which can also present the best imaging effect without lowering the flexibility of the related art.

According to an aspect of the invention, the no-drive photographing device comprises a lens for obtaining the optical image of the object. Further, the device comprises an image sensor connected to a digital signal processing unit, which is used for converting the optical image of the object obtained by the lens into a digital image signal It then sends the digital image signal to a digital signal processing unit. The digital signal processing unit is connected to an external computer device, which is used for performing real-time processing to the digital image signal, thereby obtaining a restored image signal. The restored image signal then is sent to the external computer device, wherein the digital signal processing unit has a parameter recording region for recording configuration parameters of the image sensor.

In addition, the above digital signal processing unit could comprise, for example, a Universal Serial Bus (referred to as USB) interface, for connecting the external computer device to write configuration parameters into the digital signal processing unit.

Moreover, the above digital signal processing unit could comprise a Serial Peripheral Interface (referred to as SPI) interface, an Inter-Integrated Circuit (referred to as IIC) interface or a Universal Asynchronous Receiver/Transmitter (referred to as UART) inter face for connecting an external programming device, in order to write configuration parameters into the digital signal processing unit.

In the invention, configuration parameters could comprise the type of image sensor, and the imaging parameter of the no-drive photographing device.

The invention also provides a no-drive photographing method comprising step 1, which is an external device which writes the configuration parameter of the recording image sensor into a digital signal processing unit through a parameter writing interface; step 2), which, once an optical image of the object is obtained through a lens, the image sensor then converts the optical image of the object obtained through the lens into a digital image signal, then sending the digital image signal to a digital signal processing unit; and step 3, the digital signal processing unit processing the digital image signal in real time, thereby obtaining a restored image signal, and sending the restored image signal to the external computer device.

Step 1 comprises: step a, choosing the type of the image sensor; step b, writing the configuration parameter associated with the image sensor of the type into the parameter recording region in the digital signal processing unit though the parameter writing interface according to the type; and step c, the digital signal processing unit reading the configuration parameter and configuring the image sensor of the type according to the configuration parameter.

In step b, performance is as follows: connecting the digital signal processing unit to the external computer device through the parameter writing interface; and writing the configuration parameter in the external computer device into the parameter recording region, in which the above parameter writing interface could be a USB interface.

Optionally, in step b, performance is as follows: connecting the digital signal processing unit to an external programming device through the parameter writing interface; and writing the configuration parameter in the external programming device into the parameter recording region. The above parameter writing interface could be a SPI interface, an IIC interface or a UART interface, or any other similar interfaces.

Therefore, the invention solidifies programs in the digital signal processing chip and the allocation of the sensor in the no-drive PC CAM is realized, thereby decreasing the area of the encapsulated chip, reducing the number of elements, and lowering the cost. Meanwhile, each module could be configured as desired, thereby making the design of the PCB easier, making it convenient to the offering and purchasing of these products by factories.

Other characteristics and advantages of the invention will be explained in the specification which follows, and become obvious both from the specification and also understood by practicing the invention. The objective and advantages of the invention could be realized and obtained by following the written specification, the claims, and the structure as specifically indicated in the drawings.

### BRIEF DESCRIPTION OF DRAWINGS

The present invention will become more fully understood from the detailed description given hereinafter and also from the accompanying drawing given by way of illustration only. These drawings are not understood as a definition of the limits or limitations of the present invention.

The accompanying drawings are included to provide a further understanding, of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily scaled relative to each other; for example, reference numerals which designate corresponding similar parts.

FIG. 1 is a working flow chart of a typical PC CAM.

FIG. 2 shows a working flow chart of realizing a no-drive PC CAM by adding an EEPROM to DSP in the related art.

FIG. 3 is a block diagram of the no-drive photographing device according to the present invention.

FIG. 4 is a schematic work flow chart of performing parameters programming process to the DSP) from the device shown in FIG. 3, through a USB interface by an external computer device according to the first embodiment of the invention.

FIG. 5 is a schematic work flow chart of performing parameters programming process to the DSP from the device shown in FIG. 3, through an IIC interface by a programming device according to the second embodiment of the invention.

FIG. 6 is a flowchart of the no-drive photographing device according to the present invention.

FIG. 7 is a schematic work flow chart of the parameters programming, and online upgrading process for a PC CAM.

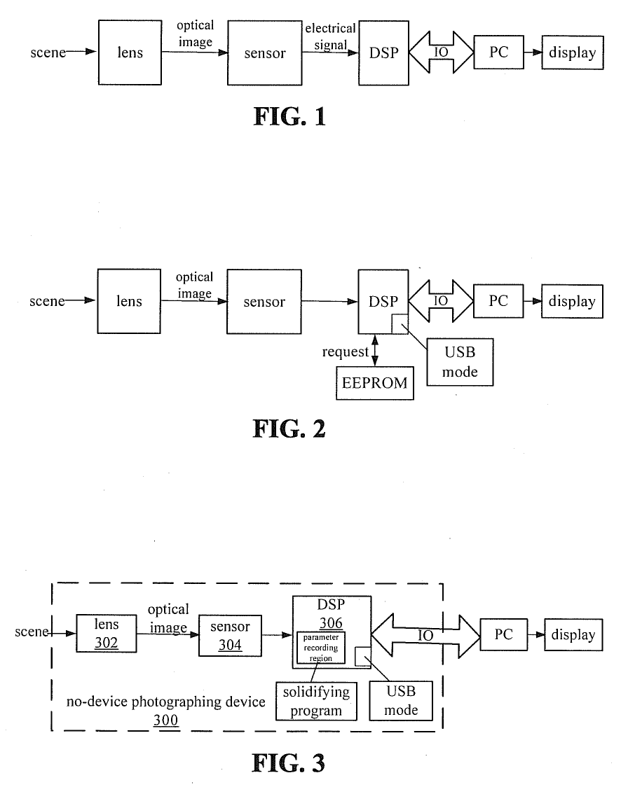

### DETAILED DESCRIPTION OF PREFERRED EMBODIMENTS

The preferred embodiments of the invention will be further explained when combined with the drawings. It should be under-stood that the preferred embodiments described here are only used for expanding and explaining the invention, and are not for limiting the invention.

FIG. 3 is a block diagram of the no-drive photographing device 300 according to the present invention. As shown in FIG. 3, the device comprises a lens 302 for obtaining the object. Additionally, the device comprises an image sensor 304 connected to a digital signal processing unit 306 for converting the optical image of the object obtained by the lens 302 into a digital image signal. The digital image signal is then sent to a digital signal processing unit (DSP) 306. The digital processing unit 306 is connected to an external computer device for performing real-time processing on the digital image signal, obtaining a restored image signal, and then sending the restored image signal to the external computer device, wherein the digital signal processing unit 306 has a parameter recording region for recording configuration parameters of the image sensor.

Moreover, the digital signal processing unit 306 could comprise a USB interface for connecting the external computer device, in order to write configuration parameters into the digital signal processing unit.

As another example, the digital signal processing unit 306 could comprise a SPI interface, an IIC interface, or a UART interface for connecting an external programming device to write configuration parameters into the digital signal processing unit.

In the present invention, configuration parameters could comprise the type of the image sensor, and the imaging parameter of the no-drive photographing device.

### First Embodiment

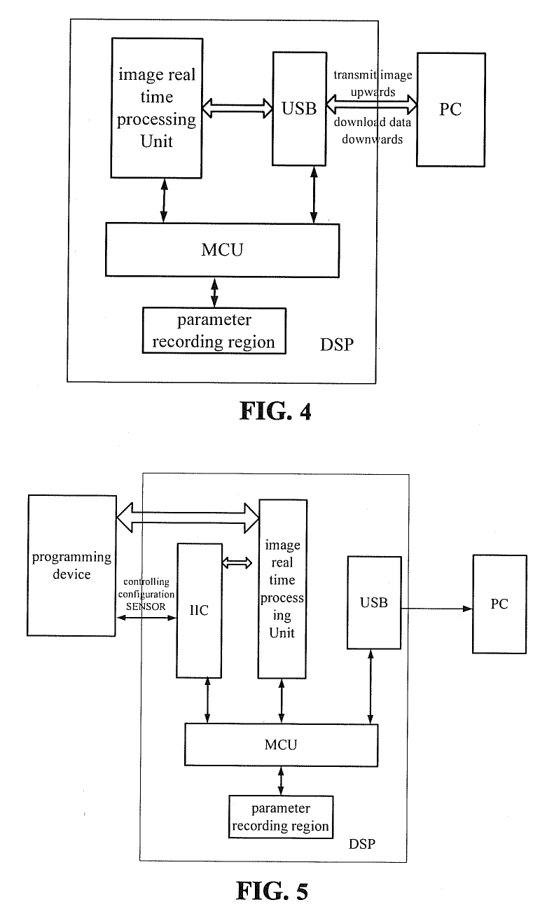

FIG. 4 is the schematic workflow of performing parameters programming process to the DSP from the device shown in FIG. 3, through a USB interface to an external computer device according to a first embodiment of the invention. As shown in FIG. 4, in the DSP process there is a USB port. Under the control of a micro controlling unit (referred to as MCU), DSP) could exchange data with the external PC device through a USB interface. Between DSP and PC, the image is transmitted upwards, i.e., transmitting the image generated in the image real time processing unit into a PC; but data are downloaded downwards. i.e., writing the configuration parameter in a PC into the parameter recording region. The parameter recording region is used for storing the configuration parameters about the sensor, so that configuration parameters are stored conveniently and easily.

### Second Embodiment

FIG. 5 is a schematic work flow of performing parameters programming process to the DSP from the device shown in FIG. 3, through an IIC interface by a programming device according to a second embodiment of the invention. As shown in FIG. 5, there is an IIC interface in the DSP. Under the control of MCU, the external programming device writes the configuration parameter into the parameter recording region by the IIC interface.

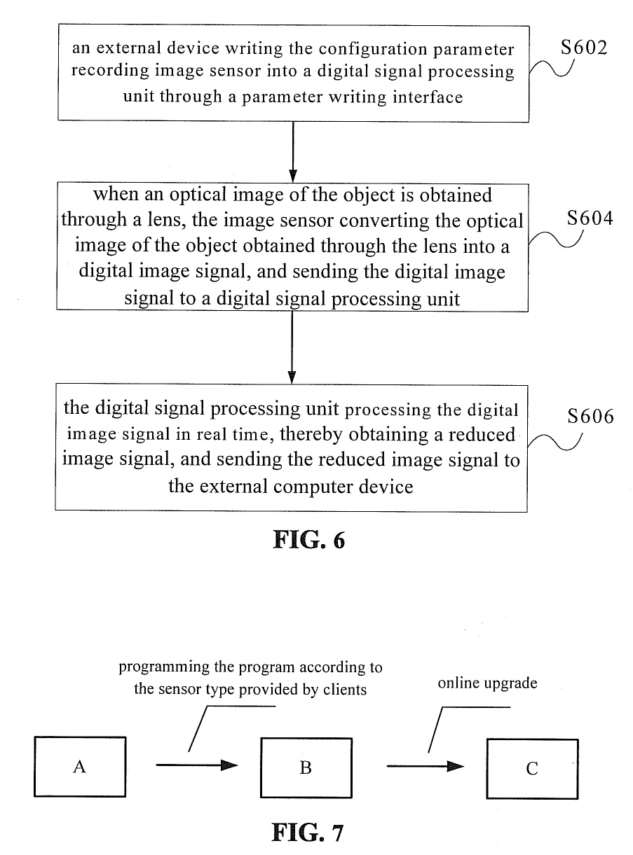

FIG. 6 is a flowchart of the no-drive photographing device according to the invention. As shown in FIG. 6, the method comprises the following steps.

First, there is an external device which writes the configuration parameter recording image sensor into a digital signal processing unit through a parameter writing interface, via step 602.

Next, when an optical image of the object is obtained through a lens, the image sensor converts the optical image of the object obtained through the lens into a digital image signal, and then sends the digital image signal to a digital signal processing unit, via step 604.

Then, the digital signal processing unit processes the digital image signal in real time, thereby obtaining a restored image signal, and then sends the restored image signal to the external computer device, via step 606.

The step 602 further comprises:

Step a, choosing the type of the image sensor.

Step b, writing the configuration parameter associated with the image sensor of the type into the parameter recording region in the digital signal processing unit through the parameter writing interface, according to the type.

Step c, the digital signal processing unit reads the configuration parameter and configures the image sensor of the type, according to the configuration parameter.

In step b, the following processes could be performed: connecting the digital signal processing unit to the external computer device through the parameter writing interface; and writing the configuration parameter in the external computer device into the parameter recording region. The above parameter writing interface could be a USB interface.

Optionally, the following processes Could be performed in step b: connecting the digital signal processing unit to an external programming device through the parameter writing interface; and writing the configuration parameter in the external programming device into the parameter recording region. The above parameter writing interface could be a SPI interface, an IIC interface or a UART interface, or any other similar interface.

FIG. 7 is the schematic work flow of the parameters programming and online upgrading process for a PC CAM. As shown in FIG. 7, A is encapsulated DSP. There is a blank parameter recording region in the DSP. B is a PC CAM finished product with matching parameters programmed according to the sensor type provided by the factory. C is an upgraded PC CAM.

It can be seen from FIG. 7 that, through the invention, DSP producing factories and sensor factories will not be limited to each other for matching problems. Therefore, the invention will bring significant improvements and convenience to the offering and purchasing of these products by factories.

Further, if the configuration parameter changes, only parameters in the part of the parameter recording region in DSP need to be updated, omitting complicated updating processes.

It can be seen from the above, that by means of the present invention, a PC CAM could be conveniently used in the purchasing and offering of these products by factories. It is also easy to update, which could achieve the purpose of batch producing. This also makes it convenient for the purchasing and offering of these products by factories.

It should be understood that the invention applies to MCU of all kinds of storage mediums (such as one/multi-time program (referred to as OTP) and multi-time program (referred to as MTP)), FLASH Memory (referred to as FLASH), wherein MTP and FLASH are storage mediums which could be upgraded online.

It can be seen from the above description, that the present invention does not need to add an EEPROM chip to DSP, so that by reducing the number of elements, and residual elements—which could be configured as desired—the design of the PCB becomes easier, as well as lowering of the cost, so that it is convenient to the offerings and purchasing of these products by factories, without changing the properties of products themselves.

Further, the invention overcomes a weakness of the present equipment while at the same time retaining properties adapted to special use (for example, batch producing and updating. The no-drive process is thus realized conveniently and easily increasing the offerings and purchases of these products by producers and clients.

As described above, the parameter inputting interface of the invention has been described by taking the USB interface connected to the PC, and also by the SPI, UART. IIC interface connected to the programming device, but it should be understood that other kinds of interfaces according to different agreements or standards should also be included in the scope of the present invention.

Whereas the present invention has been particularly shown and described with reference to the embodiments thereof it will be understood by those skilled in the art that any amendment or equivalent replacement made to the technical solution of the present invention without departing from the spirit and scope of the present invention shall all be covered by the scope of the claims of the present invention.

What is claimed is:

1. A no-drive photographing device comprising a lens for obtaining an optical image of an object, further comprising:
an image sensor connected to a digital signal processing unit, which is used for converting the optical image of the object obtained by the lens into a digital image signal, and sending the digital image signal to the digital signal processing unit; and
the digital signal processing unit connected to an external computer device, which is used for performing real-time processing to the digital image signal, thereby obtaining a restored image signal, and then sending the restored image signal to the external computer device,
wherein the digital signal processing unit has a parameter recording region for recording configuration parameters of the image sensor.

2. The device according to claim 1, wherein the digital signal processing unit comprises a Universal Serial Bus interface for connecting the external computer device, to write the configuration parameters into the digital signal processing unit.

3. The device according to claim 1, wherein the digital signal processing unit comprises a Serial Peripheral interface, an Inter-Integrated Circuit interface or a Universal Asynchronous Receiver/Transmitter interface for connecting an external programming device to write the configuration parameters into the digital signal processing unit.

4. The device according to claim 1, the configuration parameters comprising:
the type of image sensor; and
the imaging parameter of the no-drive photographing device.

5. A no-drive photographing method, comprising the steps of:
step 1, an external device writing the configuration parameter recording image sensor into a digital signal processing unit through a parameter writing interface;
step 2, in which an optical image of the object is obtained through a lens, the image sensor converting the optical image of the object obtained through the lens into a digital image signal, and sending the digital image signal to the digital signal processing unit; and
step 3, in which the digital signal processing unit processing the digital image signal processes it in real time, thereby obtaining a restored image signal, and sending the restored image signal to the external computer device.

6. The method according to claim 5, the step 1 comprising:
step (a), choosing the type of the image sensor;
step (b), according to the type of the image sensor, writing the configuration parameter associated with the image sensor of the type into a parameter recording region of the digital signal processing unit through the parameter writing interface; and
step (c), the digital signal processing unit reading the configuration parameter and configuring the image sensor of the type according to the configuration parameter.

7. The method according to claim 6, the step (b) comprising:
connecting the digital signal processing unit to the external computer device through the parameter writing interface; and
writing the configuration parameter in the external computer device into the parameter recording region.

8. The method according to claim 7, wherein the parameter writing interface is a Universal Serial Bus interface.

9. The method according to claim 6, the step (b) comprising:
connecting the digital signal processing unit to an external programming device through the parameter writing interface; and
writing the configuration parameter in the external programming device into the parameter recording region.

10. The method according to claim 9, wherein the parameter writing interface is a Serial Peripheral Interface, an Inter-Integrated Circuit interface or a Universal Asynchronous Receiver/Transmitter interface.
